(19) United States
(12) Patent Application Publication
(10) Pub. No.: US 2006/0219539 A1
(43) Pub. Date: Oct. 5, 2006

(54) Switch mat for an electrical switch

(76) Inventors: Friedhelm Lotz, Lunen (DE); Ingo Petzholz, Wiesbaden (DE); Anja Martens, Obermoschel (DE)

Correspondence Address: DELPHI TECHNOLOGIES, INC., M/C 480-410-202, PO BOX 5052, TROY, MI, 48007, US

(21) Appl. No.: 11/369,250

(22) Filed: Mar. 7, 2006

(30) Foreign Application Priority Data
Mar. 11, 2005 (EP) 05005330.5

(51) Int. Cl. H01H 3/14

(52) U.S. Cl. 200/86 R

(57) ABSTRACT

In a switch mat for an electrical switch with a back-lit actuation element, which is stored in a housing, for action on switch contacts, at least one of the switch contacts is correlated with the switch mat. The switch mat is colored dark in such a way that, on the one hand, scatter light is absorbed by the switch mat and, on the other hand, light for the back-lighting of the actuation element is allowed through by the switch mat.

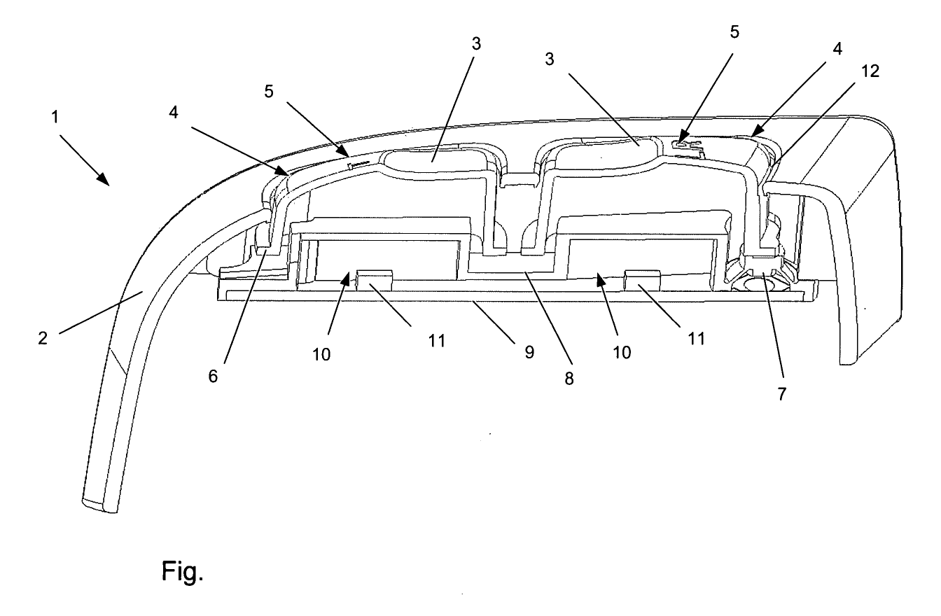

### BACKGROUND OF THE INVENTION

1. Field of the Invention

The invention refers to a switch mat for an electrical switch with a back-lit actuation element stored in a housing for action on switch contacts, wherein at least one of the switch contacts is correlated to the switch mat.

2. Description of Related Art

From actual practice, the correlation of an actuation element of an electrical switch and a switch mat with contacts held in domes for action on stationary contacts, for example, of a corresponding circuit board, is known. For the back-lighting of the actuation element which, as a rule, has a symbol, the circuit board carries means of lighting, for example, LEDs, whose light shines through the switch mat made of a transparent or slightly opaque and elastic material. It has proved problematic that light emitted from the means of lighting often negatively impairs the desired appearance of the switch, wherein the scatter light is frequently visible for a user through a slot present between the actuation element and a housing storing the actuation element, and accordingly, the optical appearance of the switch is unfavorable.

DE 196 41 786 A1shows a switch mat with individual switching elements, via which a contact to a circuit board is produced. The switch elements have cavities into which light is coupled, wherein button surfaces of the switch mat made of a light-impermeable material are permeable to light. As a result of the light impermeability of the material of the switch mat, the emission of scatter light to a design surface is avoided. In order to guarantee the light impermeability of the material of the switch mat with a simultaneously light-permeable button surface, the switch mat is first lacquered and subsequently the lacquer is removed in the area of the button surface by means of a laser, which involves considerable cost. Moreover, it is necessary, particularly for stylistic reasons, to place a rigid actuation element above the switch mat.

### BRIEF SUMMARY OF THE INVENTION

The goal of the invention is to create a switch mat of the type mentioned in the beginning, which can be made at low cost and which does not negatively influence the optical appearance of the switch by emitted scatter light.

In accordance with the invention, the goal is attained in that the switch mat is colored dark in such a way that, on the one hand, scatter light is absorbed by the switch mat and, on the other hand, light is permitted through by the switch mat, so as to back-light the actuation element.

As a result of this measure, it is not necessary to subject the actuation element or the switch mat, as known from the state of the art, to several operations, namely, lacquering and a subsequent laser, so as to guarantee, on the one hand, the back-lighting of a symbol and, on the other hand, to avoid an undesired emission of scatter light. Surprisingly, it became evident that with a defined dark coloring of the switch mat, which is to be determined by a person skilled in the art by means of a few comparison experiments, a translucence can be attained, which simultaneously brings about an absorption of reflected light rays within the housing, for example, of scatter light being emitted uncontrolled from the switch and nevertheless guarantees a light emission for the back-lighting of the actuation element. At the same time, a purposeful adjustment of the light dampening—that is, the brightness-is possible with a given light source.

In a development, the switch mat is colored with a black dye or black color pigments. Preferably, the fraction of the dye or the color pigments is smaller than 0.5%, in particular, 0.1%. With this low weight fraction of the dye or the color pigments in the total component weight, the required effects are attained.

In order to favor a purposeful radiation through the switch mat, the wall of the switch mat to be illuminated preferably has a reduced thickness, in comparison to the other walls.

Appropriately, the switch mat has at least one dome to hold a switch contact with which at least one stationary contact is correlated. When the dome is acted on by the actuation element, it bends and a corresponding circuit is closed, wherein because of its shape, the dome makes possible a tactile grasping of the switch. Preferably the stationary contact is made on a circuit board or by a pressed screen of the switch.

For the low-cost placement of a light source within the housing of the switch, the circuit board or the pressed screen preferably has a light element, especially an LED.

Preferably, the actuation element is light-permeable in a symbol area. According to one refinement, the actuation element is a button with a circumferential edge on its free end correlated with the switch mat acting on the dome of the switch mat. In this way, the placement of additional switch elements to actuate the dome is avoided.

According to another development, the switch mat affixed on the bottom has at least one bulge which spans the light element and protrudes into the actuation element. The switch mat can, for example, be placed on the circuit board or on the base of the housing. The light emitted by the light source penetrates the bulge and arrives at an area between the switch mat and the actuation element in order to back-light its symbol.

Appropriately the switch mat is made of silicone. The silicone can be colored relatively light and processed and has the required flexibility or elasticity.

It is clear that the aforementioned features and the ones below, which have yet to be explained, can be used not only in the indicated combination, but also in other combinations. The framework of the invention is defined only by the claims.

### BRIEF DESCRIPTION OF THE DRAWING

The invention is explained in more detail below, with the aid of an embodiment example, with reference to the pertinent drawing. The only FIGURE of the drawing shows a sectional representation of an electrical switch with a switch mat in accordance with the invention.

### DETAILED DESCRIPTION OF THE INVENTION

The switch 1 comprises a housing 2 in which two actuation elements 4, designed as buttons 3, with a light-permeable symbol 5 are placed on the upper side. On the underside, the buttons 3 have a surrounding edge 6, under which domes 7 of a switch mat 8 equipped with a switch contact are arranged. The switch mat 8 made of silicone, which overlaps the edge of a circuit board 9, has bulges 10, which project into the correlated button 3. Light elements 11 coupled electrically with the circuit board 9 are found in the bulges 10 for the back-lighting of the symbols 5 of the button 3 made of a light-impermeable material.

In order to avoid an undesired emission of scatter light, in particular, from a slot 12 present between the housing 2 and the buttons 3, and nevertheless to guarantee a light emission for the lighting of the symbols 5 of the buttons 3, the silicone of the switch mat 8 is colored with black dye pigments whose weight fraction is approximately 0.1%. Due to the coloring, scatter light reflected by the housing 2 or the buttons 3 is absorbed by the switch mat 8 and at the same time a back-lighting of the buttons 3 is attained.

1. Switch mat for an electrical switch with a back-lit actuation element stored in a housing for action on switch contacts, wherein at least one of the switch contacts is correlated with the switch mat, wherein the switch mat is colored dark in such a way that, on the one hand, scatter light is absorbed by the switch mat and, on the other hand, light for the back-lighting of the actuation element is allowed through by the switch mat.

2. Switch mat according to claim 1, wherein the switch mat is colored with a black dye or black color pigments.

3. Switch mat according to claim 1, wherein the fraction of the dye or the color pigments is smaller than 0.5%, in particular, 0.1%.

4. Switch mat according to claim 1, wherein the wall of the switch mat to be illuminated has a reduced thickness in comparison to the other walls.

5. Switch mat according to claim 1, wherein the switch mat has at least one dome for holding a switch contact with which at least one stationary contact is coordinated.

6. Switch mat according to claim 5, wherein the stationary contact is formed on a circuit plate or by a pressed screen of the switch.

7. Switch mat according to claim 6, wherein the circuit plate or the pressed screen carries a light element, in particular, an LED.

8. Switch mat according to claim 1, wherein the actuation element is light-permeable in a symbol area.

9. Switch mat according to claim 1, wherein the actuation element is formed as a button with a circumferential edge on its free end, correlated with the switch mat, and acts on the dome of the switch mat.

10. Switch mat according to claim 1, wherein the switch mat affixed on the bottom has at least one bulge, which spans the light element and which protrudes into the actuation element.

11. Switch mat according to claim 1, wherein the switch mat is made of a silicone.
